(19) United States
(12) Patent Application Publication
(10) Pub. No.: US 2006/0101374 A1
(43) Pub. Date: May 11, 2006

(54) Enterprise management system installer

(76) Inventors: Beng Giap Lim, Mt. View, CA (US); Wei-Chung Chen, Mt. View, CA (US); Ramon Balagot, San Mateo, CA (US); Fedor Kallay, Zilina (SK); Cathrin Barsch, Los Gatos, CA (US)

Correspondence Address: KENYON & KENYON LLP, RIVERPARK TOWERS, SUITE 600, 333 W. SAN CARLOS ST., SAN JOSE, CA, 95110, US

(21) Appl. No.: 10/965,580

(22) Filed: Oct. 14, 2004

(51) Int. Cl. G06F 9/44

(52) U.S. Cl. 717/102

(57) ABSTRACT

An installation tool is proposed for enterprise management systems using objects to install settings to a business logic portion of a computer system. An object manager may create a library of one or more enterprise management system objects. The enterprise management system objects may include settings information sufficient to cause the business logic portion of a computer system to perform in accordance with an associated business process. An installation project manager may assemble a selected group of enterprise management system objects into a project and automatically install settings based on the assembled project into the business logic portion. A subset of the enterprise management system objects may be pre-assembled into building block modules to facilitate installation.

### BACKGROUND

The present invention relates to an installation tool for use in enterprise management software (“EMS”) systems and, in particular, to an installation tool that provides a library of prefabricated installation options for the EMS system.

EMS systems are software systems typically designed to manage the operations of some of the largest companies in the world. EMS systems typically are designed for large scale system applications, involving perhaps tens of thousands of users. They are intended to manage most of the business processes that a company finds necessary in its operation, including for example, supply-chain management (“SCM”), customer relationship management (“CRM”), product lifecycle management (“PLM”) and enterprise resource planning (“ERP”), among others. While it can be expected that operations in many business functions are similar from company to company, other business functions are markedly different. Business functions in areas such as supply-chain management and product lifecycle management depend heavily on the industries in which a given company practices and the goods and services that the company provides within those industries. Indeed, business processes even in areas where companies face generic issues, such as human resources, vary from company to company as those companies design business processes to handle their unique needs.

Given the vast differences in the business processes of each company, EMS systems have been developed having a flexible architecture to accommodate them. FIG. 1 provides a simplified block diagram illustrating one such architecture. There, an EMS system 100 is illustrated as including a business logic portion 110 and a settings portions 120. When installed on a customer's system, the business logic 110 executes and interoperates with customer data 130 provided on one or more database systems.

As noted, the EMS system 100 possesses a flexible architecture. The business logic 110 may contain tens of thousands of software modules to perform various incremental functions. These modules may be interrelated with each other in almost limitless ways to define business processes at the customer site. To conform the business logic 110 of an EMS system 100 to the business processes of a given customer, installers write settings information 120 identifying exactly how the various modules are to operate, how they interact with each other and how they interact with the customer's data 130. The act of defining the settings information is one of customization—it requires software consultants that have expertise in the architecture of the business logic software 110 and also in the needs of the customer. Defining the settings often is performed using a project-based approach, requiring years of planning, design, drafting and testing before the business logic 110 software may be installed for use by a particular customer.

Commercial deployment of EMS systems 100 has involved software publishers, installers and, of course, customers. The software publisher creates the business logic software 110 with its attendant flexibility. When a customer purchases the EMS software 100 for installation, the customer typically contracts with an installer, defines its requirements and requests the installer to design the settings 120 that will cause the business logic 110 to operate in accordance with the customer's desired business processes. In practice, some installers develop expertise in particular commercial markets (e.g., the automotive industry, pharmaceutical industries, banking). These installers may have insights into their market of expertise that permit them to assist their customers to define desired business processes. Because the process of designing settings 120 and installing the EMS system 100 on a customer platform is an act of customizing the EMS system 100 for a particular application, this process is expensive.

Based on the high implementation cost traditionally associated with EMS systems, EMS systems traditionally have been considered inappropriate for use by small or mid-sized business. These entities traditionally have been unwilling to accept the high installation costs associated with EMS systems. The inventors have identified a need in the art, however, for a tool that can reduce the cost of installation of an EMS system.

### BRIEF DESCRIPTION OF THE DRAWINGS

FIG. 1 is a diagram of the architecture of an installed EMS system.

FIG. 2 is a diagram of a possible configuration of a computer system to execute the present invention.

FIG. 3 is a block diagram of one embodiment of an EMS installer.

FIG. 4 is a block diagram of one embodiment of a workbench user interface that may be used in the present invention.

FIG. 5 is an overview flowchart of one embodiment of a method for using the current invention.

FIG. 6 is a flowchart of one embodiment of the building block creation step.

FIG. 7 is a flowchart of one embodiment of some additional steps that may be performed in the building block creation process.

FIG. 8 is a flowchart of one embodiment of the project creation step.

FIG. 9 is a flowchart of one embodiment of the project checking step.

FIG. 10 is a flowchart of one embodiment of the project activation step.

FIG. 11 is a flowchart of one embodiment of the project importation step.

FIG. 12 is a flowchart of one embodiment of the project importation step.

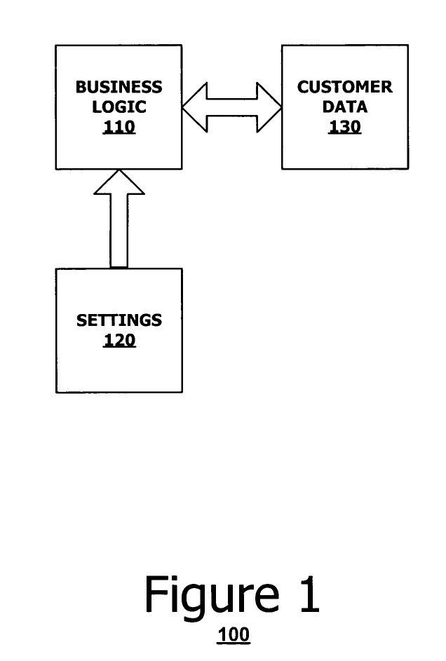

### DETAILED DESCRIPTION

An installation tool is proposed for enterprise management systems (“EMS”) using objects to install settings to a business logic portion of a computer system. An object manager may create a library of one or more enterprise management system objects. The enterprise management system objects may include settings information sufficient to cause the business logic portion of a computer system to perform in accordance with an associated business process. An installation project manager may assemble a selected group of enterprise management system objects into a project and automatically install settings based on the assembled project into the business logic portion. A subset of the enterprise management system objects may be pre-assembled into “building block” modules to facilitate installation. The enterprise management system installer may speed up installation, increase ease of use, and allow for better quality control and error checking.

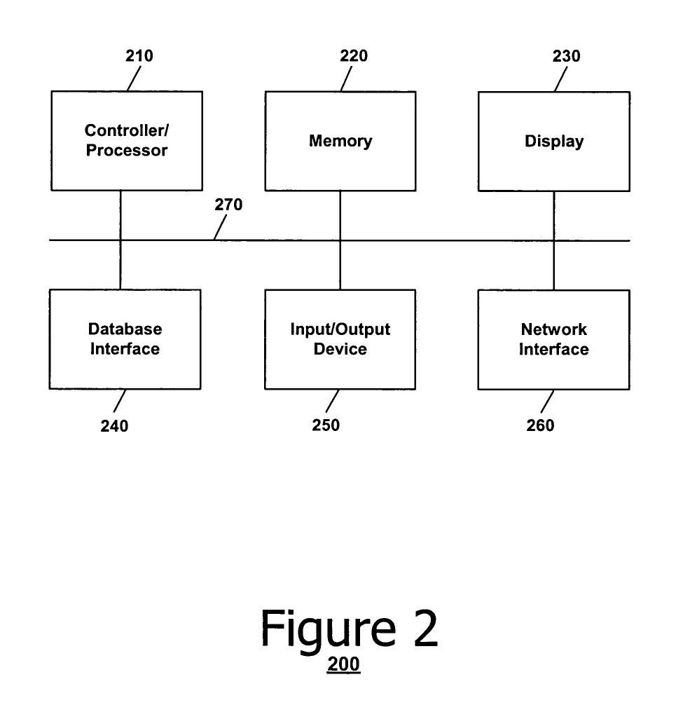

FIG. 2 illustrates a possible configuration of a computer system 200 to execute the present invention. The computer system 200 may include a controller/processor 210, memory 220, display 230, database interface 240, input/output device interface 250, and network interface 260, connected through bus 270.

The controller/processor 210 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The Input/Output interface 250 may be connected to one or more input devices that may include a keyboard, mouse, pen-operated touch screen or monitor, voice-recognition device, or any other device that accepts input. The Input/Output interface 250 may also be connected to one or more output devices, such as a monitor, printer, disk drive, speakers, or any other device provided to output data.

The memory 220 may include volatile and nonvolatile data storage, including one or more electrical, magnetic or optical memories such as a RAM, cache, hard drive, CD-ROM drive, tape drive or removable storage disk.

The network interface 260 may be connected to a communication device, modem, network interface card, or any other device capable of transmitting and receiving signals over a network 130. The components of the computer system 200 may be connected via an electrical bus 270, for example, or linked wirelessly.

Client software and databases may be accessed by the controller/processor 210 from memory 220 or through the database interface 240, and may include, for example, database applications, word processing applications, the client side of a client/server application such as a billing system, as well as components that embody the decision support functionality of the present invention. The computer system 200 may implement any operating system, such as Windows or UNIX, for example. Client and server software may be written in any programming language, such as ABAP, C, C++, lava or Visual Basic, for example.

The present invention capitalizes on a realization that, while typically no two EMS installations are exactly alike, a reasonable amount of redundancy is present across customer installations in various industries. For this reason, some EMS publishers have partnered with installers in various industries to define “best practices,” installation tips and tricks to optimize performance of the EMS system in those industries. The present invention provides an installation tool using EMS objects to extend best practices to a wider range of customers than previously thought possible.

Building blocks also may be provided to cover technical procedures to be performed at the customer site. A building block is a pre-assembled subset of EMS objects that facilitate the installation of multiple EMS objects in a pre-defined order.

Building blocks provide a mechanism through which an installer may select among a plurality of pre-defined settings to meet the business practices of his customer in an economical manner. Building blocks provide the functionality of business processes in a reusable manner, making them available for installation at multiple client sites. Building blocks also provide a convenient mechanism through which to merge the pre-defined settings with another set of settings that may be written in a customized manner. For instance, building blocks from a library of pre-defined building blocks may be installed along with building blocks written as a custom solution for the particular customer being supported.

According to an embodiment of the present invention, building blocks may be designed to coincide with a customer's business processes. Just as a customer may use business processes that are members of larger business processes, building blocks may be included as members of larger building blocks. Building blocks designed for one customer may be of use to a second customer. Safeguards may be in place to prevent the transmission of proprietary information. For those business processes that are unique to a customer, a unique building block may be designed. Other building blocks may have come from a library of pre-defined building blocks or may have been written as a custom solution for the particular customer being supported. Building blocks additionally may be combined with previously installed settings of a target system, for example, to expand functionality of the target system. For instance, building blocks defining settings for a new function for the target system may be installed to add those settings to the existing settings of the target system

Additional information may be entered by an operator during installation. Settings information, as described herein, typically involved information that defines business processes that are to be implemented by an EMS system. Building blocks also can include other processes that define communication events on a target system and how to handle them. During an installation, an operator may enter customer-centric data on which the EMS system will operate, such as names of manufacturing plants, facilities, organizational structures, materials and the like.

The foregoing description has presented the building block as containing settings information that, when installed on a client system, can cause an EMS system to perform a defined business process. According to further embodiments of the present invention, building blocks additionally may include one or more of the following:
Documentation: Reference documentation for use by customer operators when performing the business process itself. The documentation may include descriptive material regarding setup, management and data entry functions that can be performed by the business process.
Installation Interface: Data that defines a user interface during installation. The user interface may prompt an installer, for example, for information that permits the building block to interact with customer databases.
Forms: Forms associated within the business processes represented by the building block.
Test Procedure: Test methodology and processes that can be employed during installation to determine whether the building block's settings have been installed correctly and have been mapped to the customer's data appropriately.

As noted, the structure and content of a building block is determined by the business process that it is intended to achieve. By extension, the decision to include one or more of these additional features is likely to be based on the business process that the building block will achieve and the level of support that is extended to the installer.

Within the market of EMS systems, it is conventional for publishers of EMS systems to work cooperatively with the installers of these systems to develop “best practices” within particular industries. For example, various installers within a given industry (say, the automotive industry) may develop an experience base after years of working with the EMS system and with customers in the automotive industry. From their experience, these installers may identify certain best practices—business processes that provide improved performance within the relevant industry—and communicate these best practices to the EMS publisher. Conventionally, the EMS publisher would integrate settings corresponding to these best practices into the published EMS system and release them back to the installers. This collaborative process provides advantages to all the installers by providing improved performance to the EMS system.

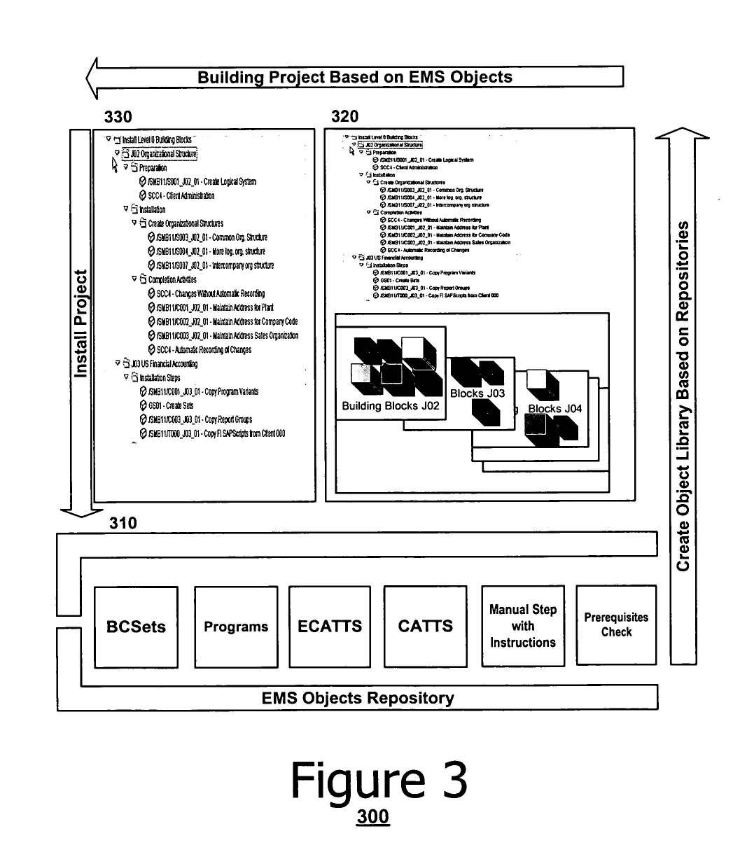

FIG. 3 illustrates in a block diagram one embodiment of an EMS installer 300. An EMS objects repository 310 may provide EMS objects to the object manager 320. The object manager may further assemble these EMS objects into building block modules. The EMS objects repository 310 may include business configuration sets (BCSets), programs, computer aided test tools (CATTS), extended computer aided test tools (ECATTS), manual steps with instructions, and prerequisite checks. The object manager 320 may also upload and download EMS objects or building blocks into the library from Excel spreadsheets. The object manager 320 may also perform standard manager functionality such as copying, editing, deleting, creating and finding EMS objects and building blocks. The installation project manager 330 may build a project based on the EMS objects or building blocks available in the object manager 320. The installation project manager 330 may also activate the building blocks objects based on the type of object. The installation project manager 330 restarts if any steps fail. The installation project manager 330 may create a log and message when each step is run. The installation project manager 320 may also perform standard manager functionality such as copying, editing, deleting, creating and finding projects. The installation project manager 330 may then install the project when the project is completed.

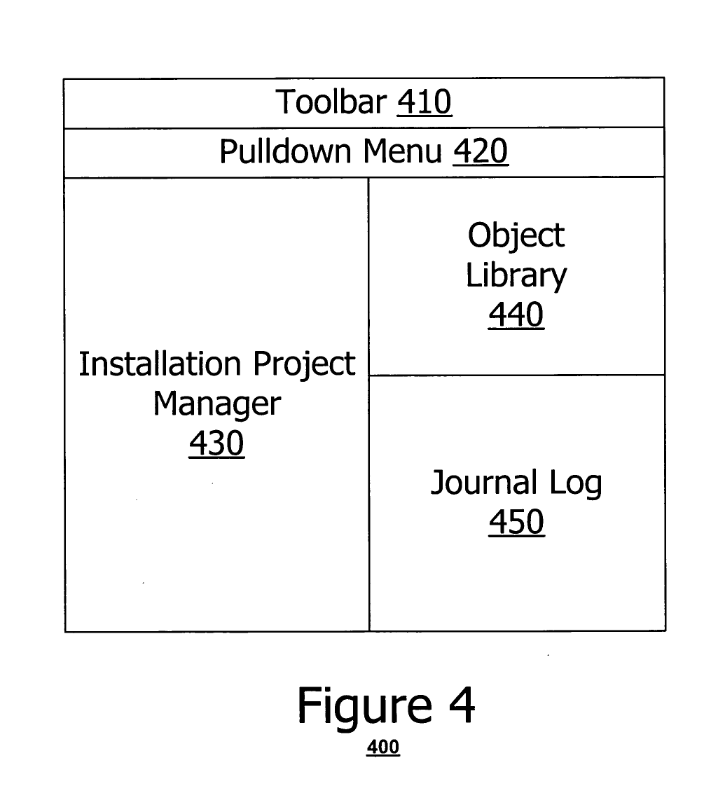

FIG. 4 illustrates in a block diagram one embodiment of a workbench user interface 400 that may be used in the present invention. The user interface 400 may have a standard toolbar 410 and pull down menu 420. A first sub-screen may represent the installer project manager 430. A second sub-screen may represent the EMS object library 440. The object library 440 may be used to create a project for use by the project manager. A third sub screen may represent a log journal 450. The log journal 450 may display log messages of a selected log.

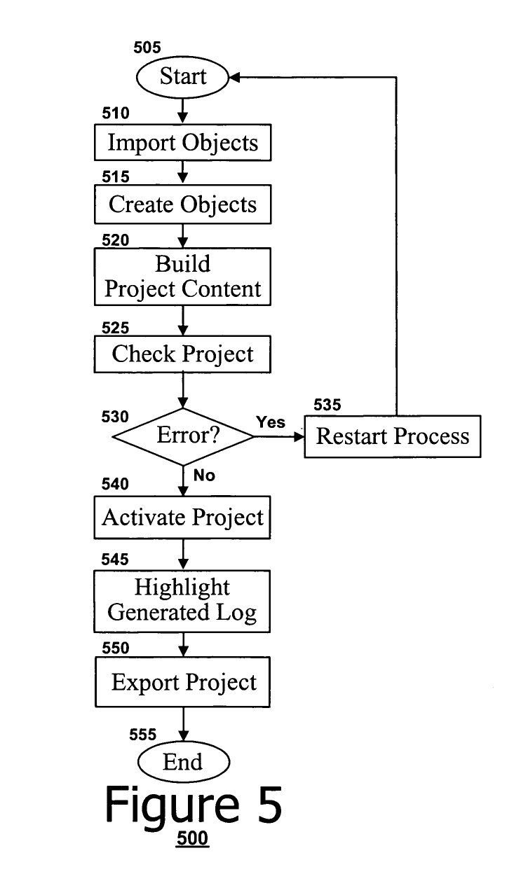

FIG. 5 illustrates in a flowchart one embodiment of an overview of a method 500 for using the current invention. The EMS installer 300, at the direction of a user, may create a project from the very beginning, finish creation of a project that has been started, or even modify an existing project. In the latter two instances, the EMS installer 300 begins (Block 505) by importing any needed existing objects (Block 510). The EMS installer 300 may also create any needed objects (Block 515). Alternately, the EMS installer 300 may install the EMS objects directly. The installer 300 then builds the project content (Block 520). The EMS installer 300 may then check the project by running a simulation of the installation of the system objects in a clean system (Block 525). If an error has occurred (Block 530), the process is restarted (Block 535). These errors may be caused by dependency issues created by EMS objects being installed in the wrong order, or other factors. Otherwise, the EMS installer 300 activates the project by using the selected objects to automatically configure all the configuration settings in the target system (Block 540). The EMS installer 300 then highlights the generated log to the user so the user may search for errors and repair them (Block 545). If the project is not to be used by the current system, the project may be exported to another system (Block 550), ending the process (Block 555).

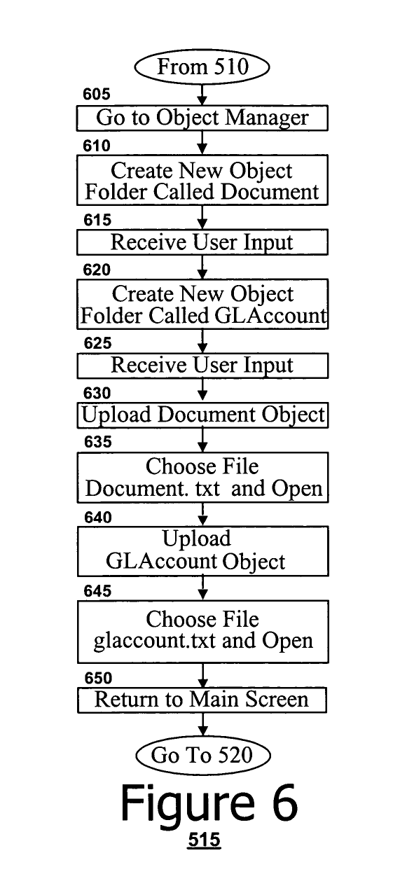

FIG. 6 illustrates in a flowchart one embodiment of the object creation step 515. The EMS installer 300 goes to the object manager (Block 605). The EMS installer 300 creates a new object folder called, for example, Document with a proper description (Block 610). The new object may be a building block. User input is received as the situation requires (Block 615). The installer 300 may then create a new object folder called, for example, GLAccount with a proper description (Block 620). Again, user input is received as the situation requires (Block 625). The EMS installer 300 uploads a document object (Block 630). The installer 300 then chooses the document.txt file and opens it (Block 635). The EMS installer 300 uploads a GLAccount object (Block 640). The EMS installer 300 then chooses the glaccount.txt file and opens it (Block 645). The EMS installer 300 returns to the main screen (Block 650) before proceeding to block 525.

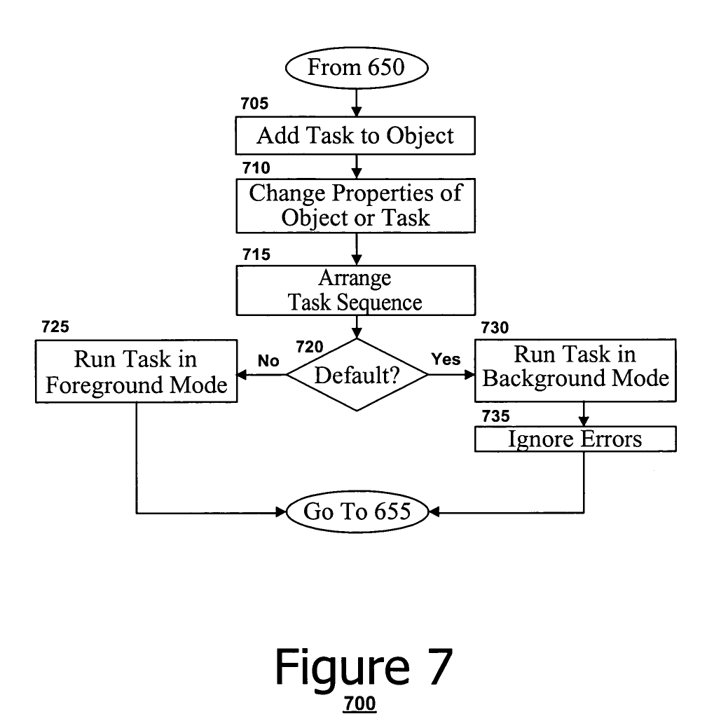

FIG. 7 illustrates in a flowchart one embodiment of some additional steps that may be performed in the object creation process 515. The EMS installer 300 may add tasks to the object (Block 705). The EMS installer 300 may also change properties of the object or the task (Block 710). The sequence of the tasks may be rearranged (Block 715). If the EMS installer 300 is not in default mode (Block 720), the tasks may be run in foreground mode (Block 725). If the EMS installer 300 is in default mode (Block 720), the tasks may be run in background mode (Block 725), and any errors are ignored (Block 735).

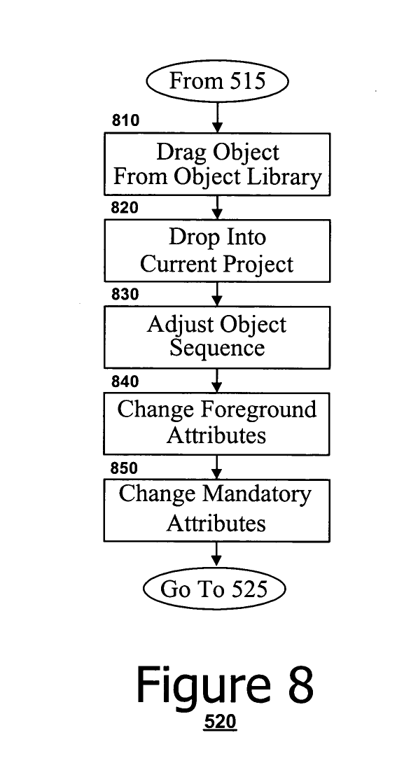

FIG. 8 illustrates in a flowchart one embodiment of the project creation step 520. The EMS installer 300 drags an EMS object from the object library (Block 810). The EMS installer 300 drops the EMS object into the current project (Block 820). The sequence of the EMS objects may be adjusted (Block 830). The foreground attributes may be adjusted (Block 840). The foreground attributes may be adjusted (Block 840).

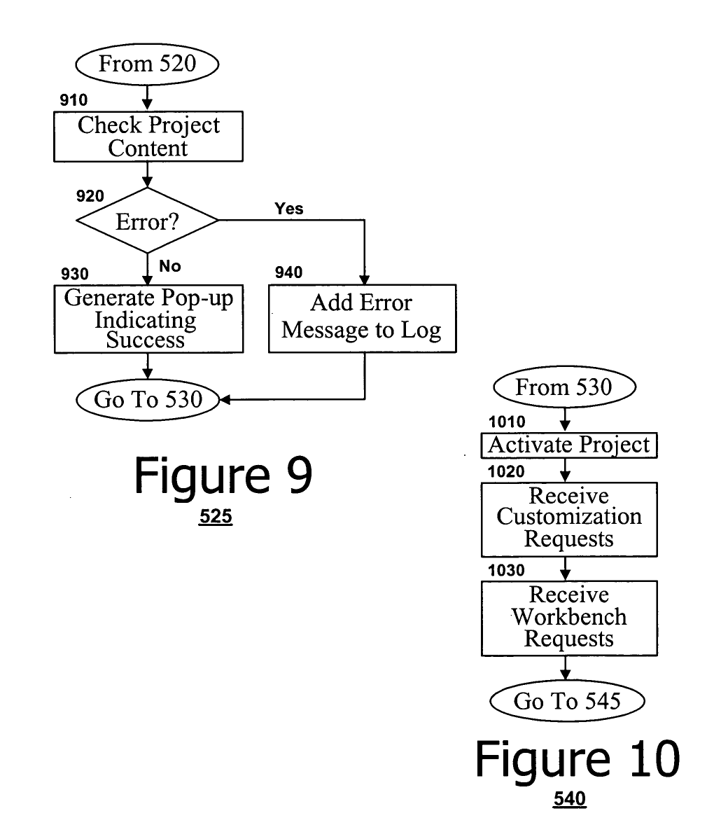

FIG. 9 illustrates in a flowchart one embodiment of the project checking step 525. The EMS installer 300 checks the project content by running a simulation of the installation of the system objects in a clean system (Block 910). If no error occurs (Block 920), then a pop-up window indicating success is generated (Block 930). If an error occurs (Block 920), then an error message is added to the log (Block 940).

FIG. 10 illustrates in a flowchart one embodiment of the project activation step 540. The EMS installer 300 activates the project (Block 1010). The EMS installer 300 may receive any customization requests from the user (Block 1020). The EMS installer 300 may receive any workbench requests from the user (Block 1030).

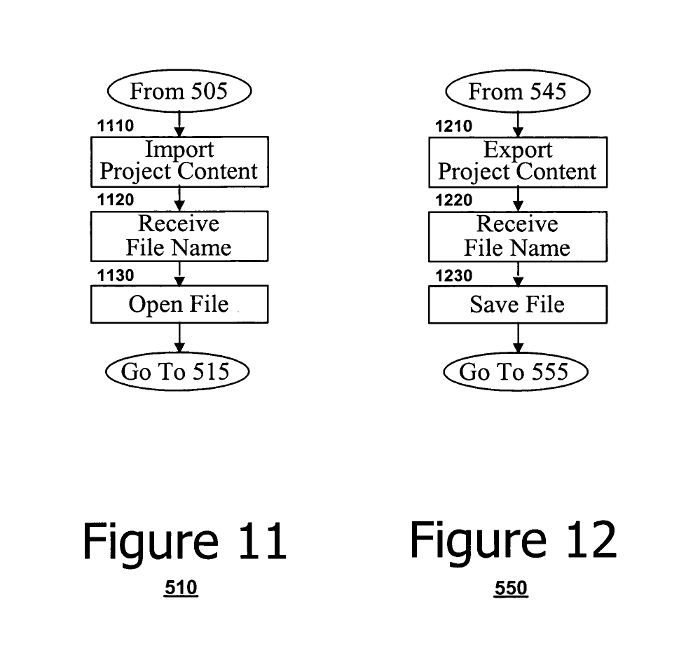

FIG. 11 illustrates in a flowchart one embodiment of the project importation step 510. As stated earlier, this step is used if a project has been already started and stored external to the system or to make modifications to an existing system. The EMS installer 300 imports the project content (Block 1110). The EMS installer 300 may receive a file name from the user (Block 1120). The EMS installer 300 then opens the file (Block 1130).

FIG. 12 illustrates in a flowchart one embodiment of the project importation step 550. As stated earlier, this step is used to store a project in a file external to the system. The EMS installer 300 exports the project content (Block 1210). The EMS installer 300 may receive a file name from the user (Block 1220). The EMS installer 300 then saves the file (Block 1130).

Several embodiments of the present invention are specifically illustrated and described herein. However, it will be appreciated that modifications and variations of the present invention are covered by the above teachings and within the purview of the appended claims without departing from the spirit and intended scope of the invention.

1. In a computer system, a method comprising:
assembling a selected group of enterprise management system objects from a library of one or more enterprise management system objects into a project, the enterprise management system objects including settings information sufficient to cause a business logic portion of the computer system to perform in accordance with an associated business process; and
automatically installing settings based on the assembled project into the business logic portion.

2. The method of claim 1, further comprising pre-assembling a subset of the enterprise manage system objects into building block modules to facilitate installation.

3. The method of claim 1, wherein the enterprise management system objects include at least one of a computer aided test tool, an extended computer aided test tool, or a business configuration set.

4. The method of claim 1, further comprising allowing a user to select a group of enterprise system management objects via a workbench user interface.

5. The method of claim 1, wherein the library of one or more enterprise management system objects are imported from an external system.

6. The method of claim 1, further comprising modifying an existing project.

7. The method of claim 1, further comprising modifying an existing enterprise management system object.

8. The method of claim 1, further comprising generating a log reporting any problems encountered while installing.

9. A set of instructions residing in a storage medium, said set of instructions capable of being executed by a storage controller to implement a method for processing data, the method comprising:
assembling a selected group of enterprise management system objects from a library of one or more enterprise management system objects into a project, the enterprise management system objects including settings information sufficient to cause a business logic portion of the computer system to perform in accordance with an associated business process; and
automatically installing settings based on the assembled project into the business logic portion.

10. The set of instructions of claim 9, further comprising pre-assembling a subset of the enterprise manage system objects into building block modules to facilitate installation.

11. The set of instructions of claim 9, wherein the enterprise management system objects include at least one of a computer aided test tool, an extended computer aided test tool, or a business configuration set.

12. The set of instructions of claim 9, further comprising allowing a user to select a group of enterprise system management objects via a workbench user interface.

13. The set of instructions of claim 9, wherein the library of one or more enterprise management system objects are imported from an external system.

14. The set of instructions of claim 9, further comprising modifying an existing project.

15. The set of instructions of claim 9, further comprising modifying an existing enterprise management system object.

16. The set of instructions of claim 9, further comprising generating a log reporting any problems encountered while installing.

17. A computer system comprising:
a memory to store a repository of enterprise management system objects;
a business logic portion to perform a business process; and
a processor to execute:
an object manager to select a group of enterprise management system objects, the enterprise management system objects including settings information sufficient to cause the business logic portion to perform in accordance with an associated business process; and
an installation project manager to assemble the selected group of enterprise management system objects into a project and to automatically install settings based on the assembled project into the business logic portion.

18. The computer system of claim 17, wherein one or more building block modules are created using a subset of the enterprise management system objects.

19. The computer system of claim 17, further comprising an input/output device to allow a user to select a group of enterprise management objects via a workbench user interface.

20. The computer system of claim 17, further comprising an input/output device to import the enterprise management objects from an external system.
